(19) United States
(12) Patent Application Publication
(10) Pub. No.: US 2025/0121660 A1
(43) Pub. Date: Apr. 17, 2025

(54) ASSEMBLY FOR MOVING A COVER

(71) Applicant: Webasto SE, Stockdorf (DE)

(72) Inventors: Julian KNÖPFLE, Stockdorf (DE); Richard SEIDL, Stockdorf (DE)

(21) Appl. No.: 18/834,818

(22) PCT Filed: Feb. 7, 2023
(86) PCT No.: PCT/EP2023/052951

§ 371 Date: Jul. 31, 2024

(30) Foreign Application Priority Data
Mar. 1, 2022 (DE) 10 2022 104 781.4

(51) Int. Cl. B60J 7/043; B60J 7/19

(52) U.S. Cl. CPC B60J 7/043; B60J 7/192

(57) ABSTRACT

An assembly for moving a vehicle roof cover having a deployment element having a twistable spring steel element that extends in an elongate manner along a longitudinal axis, wherein the spring steel element is coupleable, at a first end to a mechanical component, wherein the mechanical component is coupleable to the cover, a radially protruding locking protrusion is arranged at a second end of the spring steel element, the locking protrusion is rotatable about the longitudinal axis of the spring steel element, by the spring steel element being twisted, to be moved between a first state and a second state, wherein the spring steel element is displaceable in the longitudinal direction relative to a guide rail of the assembly in the first state and is locked so as to be unable to move in the longitudinal direction relative to the guide rail in the second state.

### CROSS-REFERENCE TO RELATED APPLICATIONS

This application is a U.S. national phase application filed under 35 U.S.C. § 371 of International Application No. PCT/EP2023/052951, filed on Feb. 7, 2023, published under WO 2023/165788 Al on Sep. 7, 2023, designating the United States, which claims priority from German Patent Application Number 10 2022 104 781.4, filed on Mar. 1, 2022, which are hereby incorporated herein by reference in their entirety.

### FIELD

An assembly for moving a cover for a vehicle roof is disclosed. In addition, a method for moving a cover for a vehicle roof is disclosed.

### BACKGROUND

Assemblies of this kind, having a cover for a vehicle roof, serve for example, for the purpose of opening starting from a closed position closing a roof opening, to first of all lift the cover in the rear region thereof by way of a deployment mechanism and then to displace it rearwardly into an open position. DE 10 2006 045 632 B3, the disclosure of which is hereby incorporated by reference, describes for example a so-called spoiler roof in this regard.

### SUMMARY

It is desirable to propose an assembly for moving a cover for a vehicle roof, said assembly allowing reliable operation.

An assembly for moving a cover for a vehicle roof has a deployment element. The deployment element has spring steel element that extends in an elongate manner along a longitudinal axis. The spring steel element is twistable. The spring steel element is twistable, in particular, about its longitudinal axis. The spring steel element has a first end and an opposite second end. At the first end, the spring steel element is coupleable to a mechanical component. The mechanical component is coupleable to the cover. For example, the mechanical component is a deployment lever, in particular a deployment lever which is assigned to a rear edge, in the main direction of travel, of the cover.

A radially protruding locking protrusion is arranged at the second end of the spring steel element. The locking protrusion is rotatable about the longitudinal axis of the spring steel element. The rotation of the locking protrusion is able to be brought about by the spring steel element being twisted. Thus, the locking protrusion is movable between a first state and a second state. The spring steel element is displaceable in a longitudinal direction of a guide rail of the assembly relative to the guide rail in the first state. The spring steel element is locked in the longitudinal direction relative to the guide rail in the second state.

According to one embodiment, an assembly for moving a cover for a vehicle roof has a deployment element that extends in an elongate manner along a longitudinal axis. The deployment element is in the form, for example, of a spring steel element or some other kind of twistable bar element. Alternatively or additionally, the deployment element has other bar elements, for example made of plastic or of a different metal.

The deployment element has a first end and an opposite second end. The deployment element is coupleable to a mechanical component at the first end. The mechanical component is coupleable to the cover. For example, the mechanical component is a deployment lever.

A radially protruding locking protrusion is arranged at the second end of the deployment element. The locking protrusion is rotatable about the longitudinal axis of the deployment element in order to be moved between a first state and a second state. The deployment element is displaceable in the longitudinal direction relative to a guide rail of the assembly in a longitudinal direction of the guide rail in the first state. The deployment element is locked so as to be unable to move in the longitudinal direction relative to the guide rail in the second state. A radially protruding guide protrusion is arranged on the deployment element between the first end and the second end. The guide protrusion and the locking protrusion are rotatable about the longitudinal axis of the deployment element relative to one another.

According to the embodiments described herein, locking of the deployment element, for example of the spring steel element, is thus brought about by means of the rotatable locking protrusion. Accordingly, locking of the mechanical component is also possible, for example, by means of the rotation of the locking protrusion and by means of the deployment element. The rotation for locking uses three-dimensional locking. In this way, reliable locking and unlocking are brought about. This also for in switching noise allows, example, a reduction and/or friction losses. Upon rotation of the locking protrusion, the spring steel element is twisted. As a result, torsional forces arise, which push the locking protrusion into its locked position. Thus, the locking protrusion is reliably held in its second state by means of the twisted spring steel element. The spring steel element is designed to allow, by means of its twist, the rotation of the locking protrusion.

For example, the locking protrusion is attached to the spring steel element. According to embodiments, the guide protrusion is attached to the spring steel element.

During operation, the guide protrusion is guided, for example, in an associated guide track in the guide rail. During operation, the guide protrusion is, for example, displaceable in the longitudinal direction and not rotatable about the longitudinal direction. The rotation and turning of the deployment element, or of the spring steel element, thus take place in a part of the deployment element between the guide protrusion and the locking protrusion.

The guide protrusion and the locking protrusion are arranged, in particular, at a defined spacing from one another. By means of the spacing, the forces are settable to defined values which arise in the deployment element during the rotation of the locking protrusion relative to the guide protrusion. Thus, even in the case of different overall lengths of the deployment element, for example for different types of covers and/or vehicle roofs and/or sunroofs, the same forces are reliably able to be brought about. The forces that arise during operation and are caused by the rotation of the locking protrusion depend on the value of the spacing. The spacing between the guide protrusion and the locking protrusion is the same, for example, even in the case of deployment elements with different lengths. Thus, in particular, the forces that arise during operation and are caused by the rotation of the locking protrusion are also the same.

According to embodiments, the deployment element is locally deformed in the region of the guide protrusion in order to avoid rotation between the guide protrusion and the deployment element. The deployment element is deformed such that it has a different cross section in certain regions transversely to the longitudinal direction. In particular, the deployment element is no longer rotationally symmetrical, at least in the deformed portion, on account of the deformation. The deformation is introduced for example by bending, hammering, stamping or some other method that can change the cross section.

According to at least one embodiment, the deployment element is alternatively or additionally locally deformed in the region of the locking protrusion in order to avoid rotation between the locking protrusion and the deployment element. In particular, the deformation in the region of the locking protrusion is formed in a manner corresponding to the deformation in the region of the guide protrusion. For example, the deformations are at an angle to one another in projection onto a plane perpendicular to the longitudinal direction. For example, in a rest state, the locking protrusion is oriented in a different direction radially with respect to the longitudinal direction than the guide protrusion.

According to at least one embodiment, the guide protrusion is made from a plastic. For example, the guide protrusion made of plastic is injection molded onto the deployment element. Alternatively, it is possible to form the guide protrusion and/or the locking protrusion only from the spring steel element, without additional plastic. For example, the deformation is provided, which is introduced for example by bending, hammering, stamping or some other method that can change the cross section.

This deformation is guided in the guide rail for example without additional plastic overmolding.

According to at least one embodiment, the locking protrusion is made from a plastic. For example, the locking protrusion made from a plastic is injection molded onto the deployment element.

According to at least one embodiment, the assembly has a plurality of sliding bodies. The sliding bodies are arranged on the deployment element between the first and the second end. For example, the assembly has two or more sliding bodies, for example six or more sliding bodies. The sliding bodies are formed in particular from plastic and injection molded for example onto the deployment element. During operation, the sliding bodies guide the deployment element in the guide rail. The sliding bodies avoid, for example, during operation, a situation whereby the deployment element is undesirably deformed when the deployment element is under compressive load.

According to at least one embodiment, the guide rail has a helical locking slotted guide. The locking slotted guide cooperates with the locking protrusion. This allows, during operation, rotation of the locking pin between the first state and the second state. The locking slotted guide is designed to turn the locking protrusion about the longitudinal axis when the locking protrusion moves in the longitudinal direction in the locking slotted guide. The locking slotted guide has a helical shape. The locking slotted guide has a spiral shape and/or screw shape. The pitch and/or radius of the locking slotted guide change, for example, in particular along the locking slotted guide. It is possible, for example, for the locking slotted guide to deviate from an ideal helix.

The locking and unlocking of the deployment element relative to the guide rail thus take place by means of rotation of the locking protrusion. This allows reliable locking.

According to one embodiment, an assembly for moving a cover for a vehicle roof has a deployment element that extends in an elongate manner along a longitudinal axis. The deployment element has a bar element that extends in an elongate manner along a longitudinal axis. The bar element is coupleable, at a first end of the bar element, to a mechanical component. The mechanical component is coupleable to the cover. A radially protruding locking protrusion is arranged at a second end of the bar element. The locking protrusion is rotatable about the longitudinal axis of the spring steel element relative to the bar element in order to be moved between a first state and a second state. The bar element is displaceable in the longitudinal direction relative to a guide rail of the assembly in the first state. The bar element is locked so as to be unable to move in the longitudinal direction relative to the guide rail in the second state.

According to a further embodiment, a spring element is arranged between the bar element and the locking protrusion. The spring element is designed and arranged so as to exert a spring force of the spring element on the locking protrusion, this spring force causing the locking protrusion to turn about the longitudinal axis relative to the bar element.

According to embodiments, the assembly is part of a spoiler roof, in which, at a rear edge in the opening direction, first of all a deployment lever is turned in order to lift the rear edge of the cover. The cover is displaced in the opening direction relative to the deployment lever in order to at least partially open up the roof opening. The deployment lever is fixed relative to the rest of the vehicle roof in this case, and not displaced in the opening direction together with the cover.

According to embodiments, the assembly is part of an externally guided sliding roof, in which the deployment lever at the rear edge of the cover is displaced together with the cover in the opening direction relative to the rest of the vehicle roof.

Further advantages, features and developments will become apparent from the following examples, which are explained in conjunction with the figures. Elements that are identical, similar and have the same action can be provided with the same reference signs throughout the figures.

### BRIEF DESCRIPTIONS OF THE DRAWINGS

In the figures:

FIG. 1 shows a schematic illustration of a vehicle according to one exemplary embodiment,

FIG. 2 shows a schematic illustration of an assembly according to one exemplary embodiment,

FIG. 3 shows a schematic illustration of an assembly according to one exemplary embodiment,

FIG. 4 shows a schematic illustration of an assembly according to one exemplary embodiment, and

FIG. 5 shows a schematic illustration of an assembly according to one exemplary embodiment.

### DETAILED DESCRIPTION

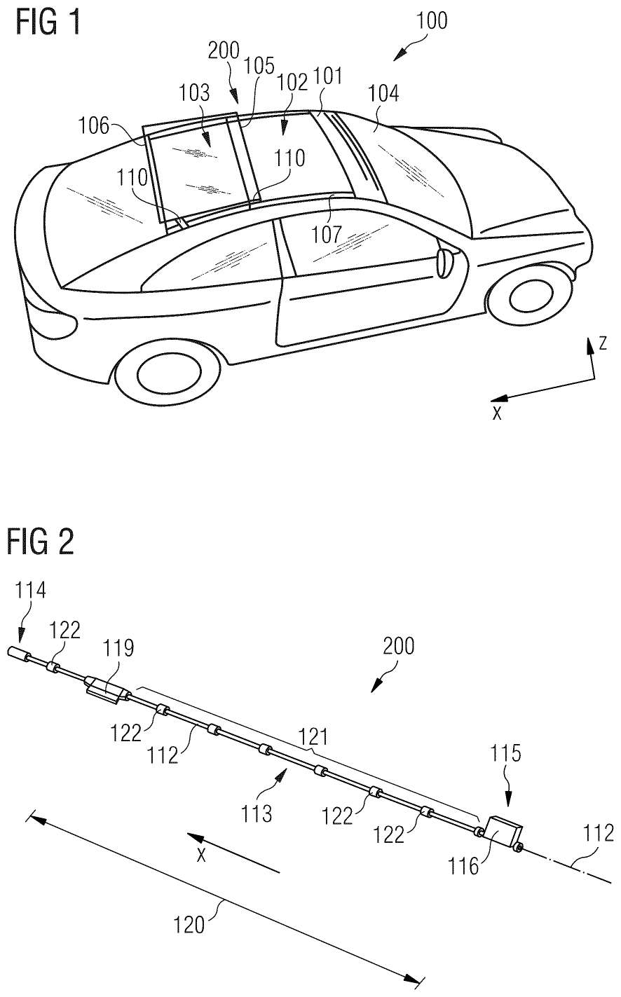

FIG. 1 shows a vehicle 100 according to one exemplary embodiment. The vehicle 100 has a vehicle roof 101. Arranged on the vehicle roof 101 is a cover 103. The cover 103 is movable for example relative to the rest of the vehicle roof 101. Thus, a roof opening 102 can be either closed by the cover 103 or partially opened up.

The vehicle has a windshield 104. The cover 103 has a front edge 105, which, in an operational state, faces the windshield 104. A rear edge 106 of the cover 103 faces away from the windshield 104 in a longitudinal direction X.

The movement of the cover 103 is brought about by means of a deployment mechanism. The deployment mechanism has, for example, a guide rail 107, which is connected to the vehicle roof 101. In the guide rail 107, a drive cable, for example, is guided. The drive cable is, for example, in contact with an electric drive motor and further components of the deployment mechanism in order to move the cover 103 relative to the rest of the vehicle roof 101. The deployment mechanism has an assembly 200, which will be explained in more detail in the following text.

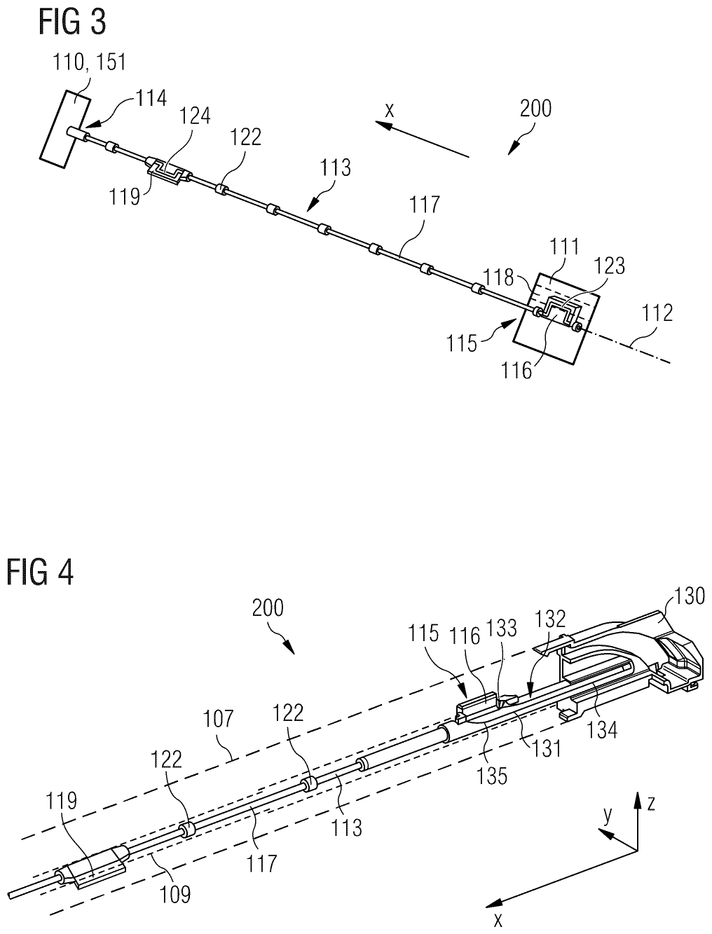

By way of example, the assembly 200 is designed in the manner of a spoiler roof. The mechanical component 110 is in the form of a rear deployment lever 151 (FIG. 3). The rear deployment lever 151 serves to lift the rear edge 106 of the cover 103. When the cover 103 is displaced in the X direction relative to the rest of the vehicle roof and into the open position, the rear deployment lever 151 is locked together with the guide rail 107. The cover 103 is displaced in the X direction relative to the deployment lever 151 in order to be displaced into its open position. In this regard, the exemplary embodiment of a spoiler roof differs from the exemplary embodiment shown in FIG. 1. FIG. 1 illustrates a so-called externally guided sliding roof, in which the deployment lever 151 at the rear edge 106 of the cover 103 is displaced together with the cover 103 in the opening direction relative to the rest of the vehicle roof. The assembly 200 described herein is also usable with this kind of sliding roof and with other configurations of sliding roofs.

Location or direction information that is used, such as rear or front, top or bottom, left or right, is in relation to a vehicle longitudinal axis and a normal direction of travel of an operational vehicle 100. The vehicle longitudinal axis may also be referred to as a horizontal axis or X axis in the associated X direction. The vehicle transverse axis may also be referred to as a horizontal axis or Y axis in the associated Y direction. The vehicle vertical axis may also be referred to as a vertical axis or Z axis in the associated Z direction. The vertical direction, the transverse direction and the longitudinal direction are, in particular, each oriented perpendicularly to one another.

FIG. 2 shows a deployment element 113 of the assembly 200 according to one exemplary embodiment. The deployment element 113 has spring steel element 117 that extends in an elongate manner, or is formed by the spring steel element 117.

The deployment element 113 extends in an elongate manner along a longitudinal axis 112. The deployment element 113 has a much greater extent along the longitudinal axis 112 than transversely to the longitudinal axis 112. In particular, the spring steel element 117 extends in an elongate manner and has a much greater extent along the longitudinal axis 112 than transversely to the longitudinal axis 112. The spring steel element 117 is, for example, a spring steel wire. The spring steel element 117 is designed for example to be round in cross section transversely to the longitudinal axis 112. Alternatively, the spring steel element 117 is designed to be angular in cross section. For example, the spring steel element 117 has an extent of between 1 mm and 3.5 mm, for example 1.5 mm or 2 mm, in cross section transversely to the longitudinal axis.

At a first end 114, the spring steel element 117 is able to be coupled to the mechanical component 110 (FIG. 3). The mechanical component 110 is, for example, the deployment lever 151 for moving the cover 103 in the vertical direction Z. According to further exemplary embodiments, the mechanical component 110 is some other element, for example a front deployment lever for moving the cover 103.

During operation, the rear deployment lever 151, which is assigned to the rear edge 106, is immovably locked, for example, relative to the guide rail 107 after the rear edge 106 of the cover 103 has been lifted in the Z direction starting from a closed position. In the closed position, the roof opening 102 is closed by the cover 103. When the cover 103 is subsequently displaced rearwardly in the longitudinal direction X, the rear deployment lever 151 is not moved together with the cover 103. The locking of the rear deployment lever 151 relative to the vehicle roof 101 and the guide rail 107 is brought about, for example, by means of the assembly 200. The spring steel element 117 is, in this state, immovably locked relative to the guide rail 107 and, at the first end 114, holds the deployment lever 151 in position. For example, the deployment lever 151 is connected directly to the spring steel element 117 or by means of further intermediate elements that are not illustrated more explicitly. In particular, rotation between the deployment lever 151 and the spring steel element 117 is possible.

A locking protrusion 116 is arranged at a front, second end 115 of the spring steel element 117. The locking protrusion 116 is made for example from a plastic. The locking protrusion 116 is connected in particular rigidly to the spring steel element 117. The locking protrusion 116 protrudes radially beyond the spring steel element 117. The locking protrusion 116 protrudes in particular perpendicularly beyond the spring steel element 117.

Sliding bodies 122 are arranged on the spring steel element 117 between the first end 114 and the second end 115. The sliding bodies 122 are made for example from plastic. The sliding bodies 122 have a larger cross section transversely to the longitudinal axis 112 than the spring steel element 117. The sliding bodies 122 are injection molded for example onto the spring steel element 117. The sliding bodies 122 are arranged at a spacing from one another. It is also possible for only one sliding body 122 to be provided or the plurality of sliding bodies 122, in particular depending on the total length of the spring steel element 117 along the longitudinal axis 112.

Between the first end 114 and the second end 115, a guide protrusion 119 is formed on the spring steel element 117. The guide protrusion 119 is made for example from a plastic.

The guide protrusion 119 is, for example, spaced apart from each of the first end 114 and the second end 115. The guide protrusion 119 is arranged at a spacing from the locking protrusion 116. The guide protrusion 119 is arranged at a spacing from the mechanical component 110.

The guide protrusion 119 is connected in particular rigidly to the spring steel element 117. The guide protrusion 119 protrudes radially beyond the spring steel element 117. The guide protrusion 119 protrudes in particular perpendicularly beyond the spring steel element 117.

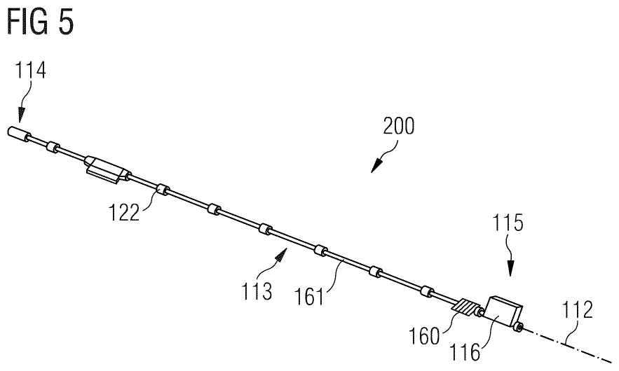

During operation, the guide protrusion 119 is guided in an associated guide track 109 (FIG. 4) of the guide rail 107. The guide track 109 extends longitudinally in the X direction. In particular, the guide protrusion 119 is guided and held by the guide track 109 such that the guide protrusion 119 is displaceable in the X direction relative to the guide rail. Rotation about the longitudinal axis 112 is avoided, however. The guide track 109 of the guide rail 107 thus extends in a straight line.

The locking protrusion 116 and the guide protrusion 119 exhibit a defined spacing 120 in the longitudinal direction X. The spacing is, for example, between 120 mm and 400 mm, in particular between 200 mm and 300 mm. The spacing 120 is defined in particular by a desired force that is generated in the spring steel element 117 upon rotation of the locking protrusion 116 relative to the guide protrusion 119. The spacing 120 is, for example, independent of the size of the cover 103 or of the guide rail 107. Thus, it is possible, for different vehicle roofs 101 and thus spring steel elements 117 with different lengths, to configure the spacing 120 to be the identical and thus to achieve defined desired, identical torsional forces when turning the locking protrusion 116.

By means of the guidance of the guide protrusion 119 in the guide track 109, only a part 121 of the spring steel element 117 is turned upon rotation of the locking protrusion 116. The part 121 is arranged between the locking protrusion 116 and the guide protrusion 119. The part of the spring steel element 117 between the first end 114 and the guide protrusion 119 is not turned. The rotational forces that act on the locking protrusion 116 are defined by the length of the part 121.

The guide protrusion 119 is also usable with the deployment elements 113 of different design. The guide protrusion 119 correspondingly makes it possible, in these exemplary embodiments too, for only the part 121 of the deployment 113 to be turned and thus for defined forces to arise during operation.

According to further exemplary embodiments that are not explicitly illustrated, it is possible to dispense with the guide protrusion 119. In particular the locking protrusion 116 is then formed on the spring steel element 117 in order, by means of the rotation of the locking protrusion 116, either to lock the deployment element 113 relative to the guide rail 107 or to enable displacement.

As is illustrated in particular in FIG. 3, the deployment element 113, in particular the spring steel element 117, is locally deformed in the region of the locking protrusion 116 and/or in the region of the guide protrusion 119 according to the exemplary embodiment. The spring steel element 119 has the deformation 123 at the second end 115. For example, the spring steel element 117 is bent, flattened or changed from its original shape in some other way, in order to form the deformation 123, which is, for example, not rotationally symmetrical. The locking protrusion 116 is formed around the deformation 123, for example injection molded thereon. The deformation 123 supports the locking protrusion 116 and serves to avoid rotation about the longitudinal axis 112 between the locking protrusion 116 and the spring steel element 117.

In a manner corresponding thereto, a deformation 124 is introduced into the spring steel element 117 at the point at which the guide protrusion 117 is provided. The deformation 124 serves to avoid rotation between the guide protrusion 119 and the spring steel element 117. The rotational forces that arise during operation are thus reliably transferable from the locking protrusion 116 and the guide protrusion 119 to the spring steel element 117. The deformation may, for example, also encompass a roughening or some other material treatment of the spring steel element 117, this improving the joining of the respective plastic of the locking protrusion 116 and of the guide protrusion 119 to the spring steel element 117.

In order to rotate the locking protrusion 116 about the longitudinal axis 112 and to twist the spring steel element 117, the assembly 200 has for example a slide 111. The slide 111 is illustrated only schematically in FIG. 3. The slide 111 is guided in the guide rail 107 and driven for example by a drive cable.

The slide 111 has a slide slotted guide 118. The slide slotted guide 118 serves to guide the locking protrusion 116. The locking protrusion 116 is guided at least partially in the slide slotted guide 118 during operation. The locking protrusion 116 may also at times leave the slide slotted guide 118. When the locking protrusion 116 is not arranged in the slide slotted guide 118, it is possible for the slide 111 to move independently of the locking protrusion 118.

The slide slotted guide 118 has, for example, a helical shape. On account of the helical shape of the slide slotted guide 118, the locking protrusion 116, cooperating with a locking slotted guide 131 in the guide rail 107, is turned about the longitudinal axis 112 or about the longitudinal direction X. The turning takes place in particular through at least 45°.

The locking slotted guide 131 is formed in a slotted-guide housing 130. The slotted-guide housing 130 is manufactured for example from a plastic. The slotted-guide housing 130 is connected to the rest of the guide rail 107. The locking protrusion 116 is guided in the locking slotted guide 131. The locking slotted guide 131 has a helical shape 132. The locking slotted guide 131 has a first region 133, which is upwardly open in the Z direction. The locking slotted guide 131 has a second region 134. The second region 134 extends substantially in the X direction and is closed in the Z direction.

Formed between the first region 133 and the second region 134 is a transitional region 135. The transitional region 135 extends in a curved manner. The slotted-guide course of the locking slotted guide 131 guides the turning and rotation of the locking protrusion 116 between the first state and the second state.

In the first region 133, the locking protrusion 116 is locked along the X axis relative to the slotted-guide housing 130 and thus relative to the guide rail 107 and is not movable. In the second region 134, a relative movement between the locking protrusion 116 and the slotted-guide housing 130 and thus the guide rail 107 in the longitudinal direction X is possible. When the locking protrusion 116 is arranged in the first region 133, the deployment lever 151 is, for example, immovably locked relative to the guide rail 107 by means of the spring steel element 117.

The spring steel element 117 generates a preload, which keeps the locking protrusion 116 in the first region 133.

The spring steel element 117 is designed to exert a spring force and/or torsional force on the locking protrusion 116, resulting in the locking protrusion 116 being turned about the longitudinal axis 112. Thus, by means of the twisted spring steel element 117, a force is able to be exerted on the locking protrusion 116. In particular, the torsion of the spring steel element 117 acts in one direction on the locking protrusion 116 such that the locking protrusion 116 is pushed in the Y direction into its position illustrated in FIG. 4. The torsion acts to prevent a movement of the locking protrusion 116 out of the first region 133 of the locking slotted guide 131 into the second region 134.

By means of the displacement of the spring steel element 117, when the locking protrusion 116 is arranged in the second region 134, the deployment lever 151 is, for example, movable, in particular pivotable, relative to the guide rail 107 in order to lift or lower the rear edge 106 of the cover 103. The locking protrusion 116 is, for example, guided at times both in the slide slotted guide 118 and in the locking slotted guide 131 in order to be moved along the locking slotted guide 131 by means of the slide 111. The cooperation of a helical slide slotted guide and a helical locking slotted guide is described for example in the patent application DE 10 2019 113 142 A1, the entire disclosure of which is hereby incorporated by reference.

The spring steel element 117, which serves as a deployment element 113, allows reliable torsion even over a relatively long lifetime of the assembly 200. In terms of its material properties, the spring steel element 117 the torsion between the locking is designed for protrusion 116 and the guide protrusion 119. The matching and configuration of the necessary locking torques are reliably configurable on account of the one-piece spring steel element 117. The torques or the forces that arise are the same in particular in both directions of rotation. By means of the definition of the spacing 120, it is possible to exactly define the locking torques. By means of the thickness of the spring steel element 117, too, it is possible to define the forces that arise. The spring steel element 117 is formed in particular from a single spring steel and exhibits no joining together of different materials.

The sliding bodies 122 prevent any bending of the spring steel element 117 in particular when a force acts on the spring steel element 117 counter to the X direction from the first end 114. For example, the sliding bodies 122 are each rotatable relative to the spring steel element 117 in order to reduce the effect of the sliding bodies 122 on the turning and the forces that arise. It is also possible to form the sliding bodies 122 in multiple parts such that one part is rigidly connected to the spring steel element 117 and a further part is rotatable relative to the first part.

The deformations 123, 124 reliably bring about the unaltered orientation of the locking protrusion 116 and of the guide protrusion 119 with respect to one another. The deformations 123, 124 are, for example, each embodied as a bend in the spring steel element 117, that is to say for example by bending. It is also possible to deform the spring steel element 117 by hammering or stamping. According to exemplary embodiments, a deformation is also provided in the region of each of the sliding bodies 122.

The spring steel element 117 has, for example, a round, oval or angular, in particular square cross section. A wide variety of cross sections for the spring steel element 117 are possible, in particular depending on desired locking torques and a desired rotation behavior.

The spring steel element 117 may also be referred to as a torsion bar spring or spring steel wire. In particular, the deployment element 113 exhibits spring steel as material, in order for it to be possible to reliably bring about the rotation of the locking protrusion 116. The torques that act on the locking protrusion 116 during operation are defined by the material of the spring steel, the shape and the diameter of the spring steel element 117 or the length of the spring steel element 117 that is turned and is defined by the spacing 120.

FIG. 5 shows the assembly 200 according to a further exemplary embodiment. The assembly 200 corresponds substantially to the assembly as explained in conjunction with FIGS. 2 and 3. In contrast to the deployment element 113 explained in conjunction with FIGS. 2 and 3, when the locking protrusion 116 is turned, no spring steel element 117 is twisted. The assembly 200 according to FIG. 5 has a rigid bar element 161 that extends in an elongate manner along the longitudinal axis 112. The bar element 161 is designed for example to be stiff. For example, the bar element 161 is designed to be solid. For example, the bar element 161 is designed to be hollow in the manner of a tube. The bar element 161 exhibits for example a metal, in particular steel, or a plastic, or is made from a metal or plastic.

In a comparable manner to the spring steel element 117, at the first end 114, the bar element 161 is able to be coupled to the mechanical component 110 (FIG. 3).

The locking protrusion 116 is arranged at a front, second end 115 of the bar element 161. The locking protrusion 116 is made for example from a plastic. The locking protrusion 116 protrudes radially beyond the spring steel element 117. The locking protrusion 116 protrudes in particular perpendicularly beyond the spring steel element 117.

The locking protrusion 116 is movably connected to the bar element 161 such that a rotation of the locking protrusion 116 about the longitudinal axis 112 relative to the bar element 161 is possible. The turning and rotation of the locking protrusion 116 between the first state and the second state, when the locking protrusion 116 moves along the locking slotted guide 131, thus takes place in particular without torsion of the bar element 161. The bar element 161 is, for example, not turned to move the locking protrusion 116. The locking protrusion 116 is turned relative to the bar element 161. The turning of the locking protrusion 116, which is caused by the locking slotted guide 131, thus, in particular, does not result in twisting of the bar element 161. The locking protrusion 116 and the bar element 161 are coupled together for example in the manner of a hinge in order to allow them to turn relative to one another.

According to exemplary embodiments, a spring element 160 is arranged between the locking protrusion 116 and the bar element 161. The spring element 160 is supported at one end on the bar element 161. At the other end, the spring element 160 is supported on the locking protrusion 116. For example, the spring element 160 has a spiral spring which is wound around the bar element 161. Other configurations of the spring element 160 are also possible; for example, the spring element 160 is in the form of a leg spring.

The spring element 160 is designed to exert a spring force on the locking protrusion 116, which results in the locking protrusion 116 turning about the longitudinal axis 112 relative to the bar element 161. Thus, by means of the spring element 160, a force is able to be exerted between the bar element 161 and the locking protrusion 116, this force corresponding to the torsional force when the spring steel element 117 is twisted. In particular, the spring force of the spring element 160 acts in a direction which pushes the locking protrusion 116 in the Y direction into its position illustrated in FIG. 4. The spring force acts to prevent the locking protrusion 116 from moving out of the first region 133 of the locking slotted guide 131 and into the second region 134. By means of the spacing 120, the properties in terms of torsion and thus the forces that act on the locking protrusion 116 are able to be defined reliably and precisely.

The assemblies 200 according to the exemplary embodiments thus allow reliable locking and unlocking by means of the three-dimensional locking. Switching noise and/or friction losses can thus be reduced. Force vectors that arise during operation can be flexibly defined and set.

### REFERENCE SIGNS

100 Vehicle
101 Vehicle roof
102 Roof opening
103 Cover
104 Windshield
105 Front edge
106 Rear edge
107 Guide rail
109 Guide track for guide protrusion
110 Mechanical component
111 Slide
112 Longitudinal axis
113 Deployment element
114 First end
115 Second end
116 Locking protrusion
117 Spring steel element
118 Slide slotted guide
119 Guide protrusion
120 Spacing
121 Part of the deployment element
122 Sliding body
123 Deformation
124 Further deformation
130 Slotted-guide housing
131 Locking slotted guide
132 Helical shape
133 First region
134 Second region
135 Transitional region
151 Deployment lever
160 Spring element
161 Bar element
200 Assembly
X Longitudinal direction
Y Transverse direction
Z Vertical direction

1. An assembly for moving a cover for a vehicle roof, having:
a deployment element which has a twistable spring steel element that extends in an elongate manner along a longitudinal axis, wherein
the spring steel element is coupleable, at a first end of the spring steel element, to a mechanical component, wherein the mechanical component is coupleable to the cover,
a radially protruding locking protrusion is arranged at a second end of the spring steel element,
the locking protrusion is rotatable about the longitudinal axis of the spring steel element, by the spring steel element being twisted, in order to be moved between a first state and a second state, wherein the spring steel element is displaceable in the longitudinal direction relative to a guide rail of the assembly in the first state and is locked so as to be unable to move in the longitudinal direction relative to the guide rail in the second state.

2. The assembly according to claim 1, wherein a radially protruding guide protrusion is arranged on the spring steel element between the first end and the second end, wherein the guide protrusion and the locking protrusion are rotatable about the longitudinal axis of the spring steel element relative to one another.

3. An assembly for moving a cover for a vehicle roof, having:
a deployment element that extends in an elongate manner along a longitudinal axis, wherein
the deployment element is coupleable, at a first end of the deployment element, to a mechanical component, wherein the mechanical component is coupleable to the cover,
a radially protruding locking protrusion is arranged at a second end of the deployment element,
the locking protrusion is rotatable about the longitudinal axis of the deployment element in order to be moved between a first state and a second state, wherein the deployment element is displaceable in the longitudinal direction relative to a guide rail of the assembly in the first state and is locked so as to be unable to move in the longitudinal direction relative to the guide rail in the second state, and
a radially protruding guide protrusion is arranged on the deployment element between the first end and the second end, wherein the guide protrusion and the locking protrusion are rotatable about the longitudinal axis of the deployment element relative to one another.

4. The assembly according to claim 2, wherein the deployment element is locally deformed in the region of the guide protrusion in order to avoid rotation between the guide protrusion and the deployment element.

5. The assembly according to claim 2, wherein the guide protrusion is made from a plastic.

6. The assembly according to claim 2, wherein the guide protrusion and the locking protrusion are arranged at a defined spacing from one another such that, when the locking protrusion is turned relative to the guide protrusion, only a part, corresponding to the spacing, of the deployment element is turned.

7. The assembly according to claim 1, wherein the deployment element is locally deformed in the region of the locking protrusion in order to avoid rotation between the locking protrusion and the deployment element.

8. An assembly for moving a cover for a vehicle roof, having:
a deployment element which has a bar element that extends in an elongate manner along a longitudinal axis, wherein
the bar element is coupleable, at a first end of the bar element , to a mechanical component, wherein the mechanical component is coupleable to the cover,
a radially protruding locking protrusion is arranged at a second end of the bar element,
the locking protrusion is rotatable about the longitudinal axis relative to the bar element in order to be moved between a first state and a second state, wherein the bar element is displaceable in the longitudinal direction relative to a guide rail of the assembly in the first state and is locked so as to be unable to move in the longitudinal direction relative to the guide rail in the second state.

9. The assembly according to claim 8, wherein a spring element is arranged between the bar element and the locking protrusion, wherein the spring element is designed and arranged so as to exert a spring force of the spring element on the locking protrusion, this spring force causing the locking protrusion to turn about the longitudinal axis relative to the bar element.

10. The assembly according to claim 1, having a plurality of sliding bodies which are arranged on the deployment element between the first end and the second end.

11. The assembly according to claim 1, wherein the locking protrusion is made from a plastic.

12. The assembly according to claim 1, wherein the guide rail has a helical locking slotted guide which cooperates with the guide protrusion in order to move the locking protrusion between the first state and the second state.
